(19) United States
(12) Patent Application Publication
(10) Pub. No.: US 2002/0093753 A1
(43) Pub. Date: Jul. 18, 2002

(54) Method and apparatus for avoiding collision of head in disk drive

(76) Inventor: Masaru Atsumi, Ome-shi (JP)

Correspondence Address: PILLSBURY WINTHROP, LLP, P.O. BOX 10500, MCLEAN, VA, 22102, US

(21) Appl. No.: 10/021,314

(22) Filed: Dec. 19, 2001

(30) Foreign Application Priority Data
Dec. 21, 2000 (JP) 2000-389067

(51) Int. Cl. G11B 21/02; G11B 15/46; G11B 19/02

(52) U.S. Cl. 360/73.03; 360/25; 360/69; 360/75

(57) ABSTRACT

A disk drive is disclosed which provides a function of restoring a flying head to its normal flying state in the event that the head comes into contact with the surface of a rotating disk due to disturbance and if recovery from the contact state is allowed. When contact or collision of the head with the disk is detected by a collision monitor, a CPU determines whether or not recovery from the contact state is possible on the basis of the condition of disturbance detected by a sensor. The CPU, on determining that recovery from the contact state is possible, carries out a contact avoidance operation to restore the head to its normal flying state.

### CROSS-REFERENCE TO RELATED APPLICATIONS

This application is based upon and claims the benefit of priority from the prior Japanese Patent Application No. 2000-389067, filed Dec. 21, 2000, the entire contents of which are incorporated herein by reference.

### BACKGROUND OF THE INVENTION

1. Field of the Invention

The present invention generally relates to a disk drive such as a hard disk drive, and more specifically to a disk drive having a function of avoiding collision or contact between head and disk.

2. Description of the Related Art

In recent years, with disk drives, particularly hard disk drives, remarkable advances have been made in recording density. With increasing recording density, the flying height of the head corresponding to spacing between the head and disk is becoming reduced to near zero. Here, the head is constructed such that a read head element and a write head element are mounted on a slider. At data read/write time, the disk is rotated at high speed by a spindle motor.

With such disk drives, the margin for the flying height of the head (clearance margin) is set small. Thus, even a slight variation in the flying height of the head may result in a situation in which the head comes into contact or collision with the surface of the disk. The frequent occurrence of such a situation increases the possibility of head crash or damage to the disk surface.

Small-sized hard disk drives (HDD) in particular have found extensive applications in notebook personal computers, mobile information equipment, digital information equipment aboard automobiles, etc. For this reason, the demand has been made of technical specifications for conventionally inconceivable use environments. Specifically, the use environments include highlands where the air pressure is low, environments susceptible to vibrations or shock, environments in which the ambient temperature is subject to wide variations, etc. Varying use environments, which can be treated as disturbance against the disk drives, cause the head position and the read/write characteristics to vary. For example, when the air pressure drops, the dynamic pressure of air generated with rotary motion of the disk is lowered, increasing the possibility that the head flying height may be decreased. In addition, when the disk drives receive a shock, the possibility of collision of the head with the disk surface will increase.

The relationship between the flying height of the head and the air bearing will be described briefly here. The flying height depends on the air bearing attendant on the high-speed rotation of the disk. Thus, when the rotational speed of the disk is lowered, the flying height of the head decreases. As described previously, even when the air pressure drops, the air bearing is lowered.

FIG. 6 shows the relationship between the flying height of the head and the air bearing. Specifically, the rotational speed (rpm) of the disk (in other words, variations in the air bearing) is shown on the horizontal axis and the degree to which the head comes into contact with the disk is shown on the vertical axis. The values on the vertical axis are ones obtained by a piezoelectric transducer (acceleration sensor) and represent collision power when the head comes into contact with the disk. That is, an acceleration sensor attached to the head senses vibrations the level of which corresponds to the degree to which the head comes into contact with the disk and then outputs a detected signal for collision power.

When the rotational speed of the disk is lowered gradually from normal speed (RPMs) to given speed (RPMa), the collision power abruptly rises (refer to arrow 60 at point P2). This means that the head has come into contact with the disk as a result of the head flying height having reduced due to the lowered rotational speed of the disk. Here, the collision power at level N represents the normal running state in which the head maintains the given flying height. On the other hand, the collision power at level H represents the contact running state in which the head is in contact with the disk.

Conventionally it is supposed that the distance between points P1 and P2 (indicated at 61) corresponds to the flying height margin (that is within the permissible range). On the other hand, when the rotational speed of the disk is increased gradually with the head in contact with the disk (refer to arrow 62), the collision power is not lowered and the contact of the head with the disk is maintained until the given speed (RPMa) is reached. When the rotational speed is further increased to RPMb higher than RPMa, the collision power falls abruptly (refer to arrow 63). At point P3, the head comes to fly above the disk surface again.

Such a hysteresis phenomenon seems to take place because, once the head comes into contact with the disk surface, the slider comes to repeat minute vibrations to prevent the head from flying. Even when the head is in the state on the lower side of the hysteresis loop (the state in which the collision power is at N level corresponding to the normal running state), the head, on exposure to disturbance (refer to dotted arrow 64), such as a variation in air pressure or shock, comes into contact with the disk surface. That is, a transition is made from the lower side of the hysteresis loop to the upper side (the state in which the collision power is at H level corresponding to the contact running state). Thus, the practical flying height margin corresponds to the distance (indicated at 65) between the points P1 and P3.

The condition of the head when the disk drive undergoes shock or air pressure variations will be described next with reference to FIG. 7.

As described above, the practical flying height margin corresponds to the distance (65) between the points P1 and P3, which is also a margin for disturbance. Upon undergoing disturbance, the head temporarily makes a transition from the normal running state (point P1) to the state of contact with the disk (point P4)(refer to dotted arrow 70). However, this is not a serious problem because the head will be restored automatically to the normal flying state (refer to dotted arrow 71).

The disk drive is also expected to be forced to operate in a state (point P5) outside the range of the flying height margin (65) in a low-pressure environment. In this case, the head and the disk are in a state of continuous light contact with each other; however, a virtually normal read/write operation can be carried out. With conventional disk drives, even if seek errors, servo errors, or drift off is detected, usual operations are continued, but the write operation is suppressed. However, even continuous light contact between head and disk will considerably reduce the life of disk drives as products.

As described previously, with recent disk drives, the flying height of the head is increasingly reduced with increasing recording density. When such drives are used in a low-pressure environment, there arises the possibility that the head may be placed in the state at point P6 on the lower side of the hysteresis loop as shown in FIG. 8. That is, the air bearing resulting from disk rotation is lowered to the extent that the flying height of the head is outside its margin. When undergoing disturbance (80) in such a state, the head comes into contact with the disk (contact running state at point P7). In this state, the air pressure is low and the air bearing has been lowered; therefore, even if disturbance is removed, there arises the possibility that force (81) to restore the head to the original floating state may fail to act, i.e., the head may be kept in contact with the disk.

As described above, since disk drives have come into use in diverse environments, provisions for avoiding situations in which the head comes into contact or collision with the disk no matter where they are used have become increasingly important.

Conventionally, a technique has been proposed in which an air pressure sensor is incorporated in a disk drive and the rotational speed of the disk is changed (increased) when a change in air pressure is detected by the sensor (see Japanese Unexamined Patent Publication No. 10-177774). However, since this technique presumes contact between the head and the disk through a change in air pressure (in other words, disturbance against air bearing), it is impossible to cope with other disturbance than a change in air pressure or a situation in which contact between the head and the disk lasts even after the effect of disturbance has been eliminated. That is, even a slight shock applied to the disk drive can cause the head to come into contact with the disk (see FIG. 7). In addition, even after the effect of the disturbance has been eliminated, the contact state may last (see FIG. 8).

In summary, when the flying height of the head is further decreased with increasing recording density, the frequency of occurrence of contact between the head and the disk will increase with certainty. Conventionally, a method has been proposed which, on occurrence of a contact state, performs an emergency operation such as of stopping the operation of the disk drive. However, with this method, the emergency operation will be carried out even in the case where the head can be restored to its normal operating state, which degrades the performance of the disk drive.

### BRIEF SUMMARY OF THE INVENTION

It is an object of the present invention to provide a disk drive which is configured to provide a function of, in the event that a flying head comes into contact with the surface of a rotating disk and if recovery from the contact state is possible, restoring the head to its normal flying state, thereby allowing the reliability to be ensured and the degradation of the performance to be kept at a minimum.

According to an aspect of the present invention, there is provided a disk drive comprising: a head adapted to fly above the surface of a rotating disk for reading or writing data on the disk; a collision monitor for detecting continuous contact of the head with the surface of the disk; a sensor for detecting disturbance; and a controller for, in the event that the continuous contact of the head with the surface of the disk is detected by the collision monitor and disturbance is detected by the sensor, performing a head contact avoidance operation.

### BRIEF DESCRIPTION OF THE SEVERAL VIEWS OF DRAWING

FIG. 1 is a schematic block diagram of a disk drive according to an embodiment of the present invention;

FIG. 2 is a cutaway view in perspective of the disk drive of the embodiment;

FIG. 3 is a diagram for use in explanation of states of the head according to a modification of the embodiment;

FIG. 4 is a flowchart illustrating the operation of the disk drive according to the embodiment;

FIG. 5 is another flowchart illustrating the operation of the disk drive according to the modification;

FIG. 6 is a diagram for use in explanation of the relationship between the flying height of the head and air bearing in the prior art; and

FIGS. 7 and 8 are diagrams for use in explanation of the head states in the prior art.

### DETAILED DESCRIPTION OF THE INVENTION

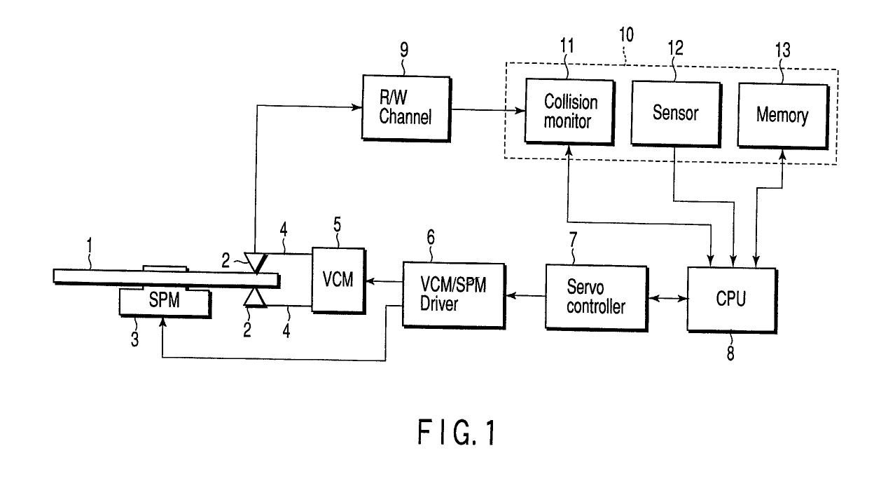

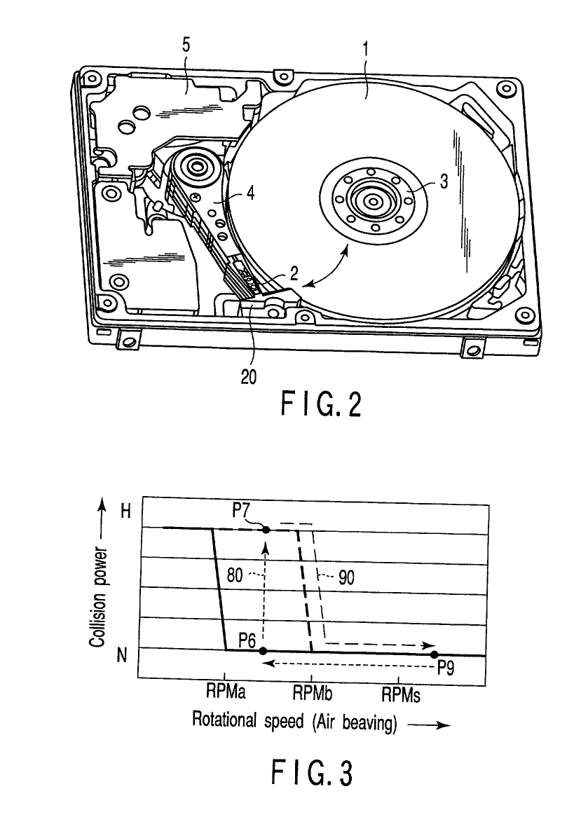

FIG. 1 shows, in block diagram form, a disk drive of the present invention. FIG. 2 depicts, in perspective, the internal structure of the disk drive.

As shown in FIGS. 1 and 2, the disk drive includes a disk 1 as a data recording medium, read/write heads 2, a spindle motor (SPM) 3 for holding and rotating the disk 1, actuators 4 which carry the heads 2, and a voice coil motor (VCM) 5 for driving the actuators 4.

The actuators 4 are driven by the VCM 5 in a radial direction relative to the disk 1 as shown by arrows in FIG. 2. In a given position outside the disk 1 is provided a ramp member 20 for parking the heads 2. As will be described later, moving the heads 2 to the disk 1 is referred to as a load operation and moving the heads back to the ramp member 20 is called an unload operation. Each of the heads 2 is comprised of a slider and a read head element and a write head element which are mounted on the slider.

Further, the disk drive includes a motor driver 6, a servo controller 7, a microprocessor (CPU) 8, a read/write (R/W) channel 9, and a head contact sense circuit 10. The motor driver 6 is a VCM/SPM driver in the form of an integrated circuit that contains drivers for the SPM 3 and the VCM 5. The servo controller 7 converts the results of operations for head position control from the CPU 8 into control signals to control the motor driver 6.

The CPU 8, which is the main controller of the drive, performs head position control, SPM drive control, and inventive contact avoidance control and emergency operations. The R/W channel 9, which is a data processing circuit, carries out a process of recovering servo data and user data from signals read by the heads 2 from the disk 1. In addition, the channel 9 performs a process of producing a write signal corresponding to write data to be recorded on the disk 1.

The head contact sensing circuit 10 comprises a collision monitor 11, a number of sensors 12, and a memory 13. The collision monitor 11 detects a state of contact or collision of the head 2 with the disk 1 and presents the result to the CPU 8. The collision monitor is configured to detect a state of collision (contact) between the head and the disk on the basis of collision power contained in the frequency components of servo data (which, in practice, is a position error signal) read from the disk 1. Alternatively, the collision monitor may be configured to detect collision (contact) between the head and the disk on the basis of an output signal from a piezoelectric sensor mounted on the head 2 or the actuator 4. The collision monitor may be incorporated into the R/W channel 9.

The sensors 12 include an air pressure sensor, an acceleration sensor, and a temperature sensor and detect disturbance, such as a change in air pressure (particularly, a drop in air pressure), shock or vibration, and a change in ambient temperature. The sensors may be at least one of the air pressure sensor and the acceleration sensor. The temperature sensor is dispensable. The memory 13, consisting of a nonvolatile memory, such as a flash EEPROM, stores the number of collisions detected by the collision monitor 11 and collision related information such as continuous contact time.

Though not shown, the disk driver is provided with a disk controller that interfaces to a host system, such as a personal computer or digital equipment.

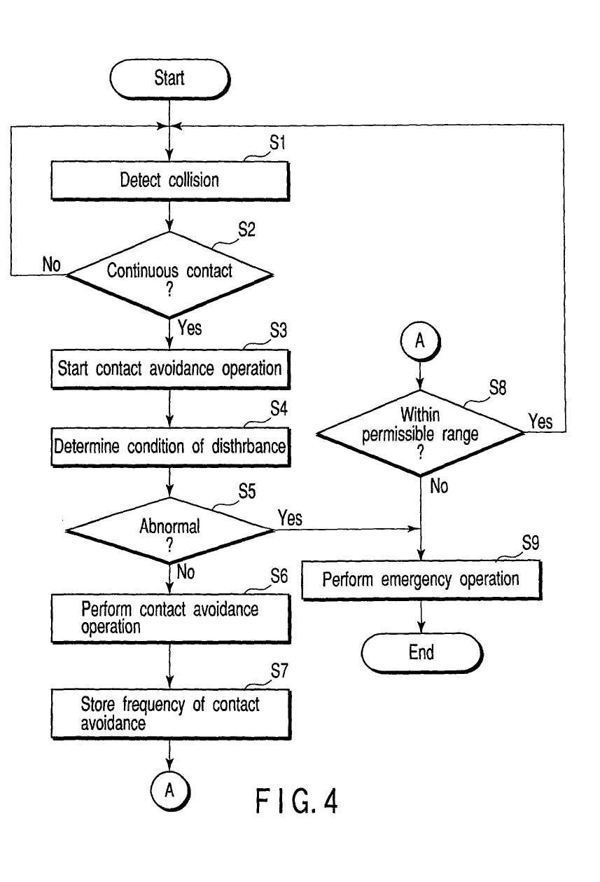

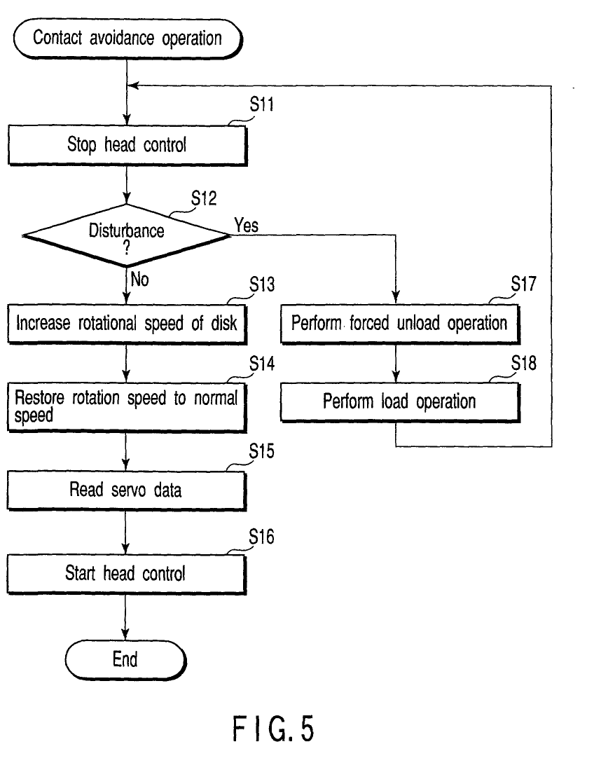

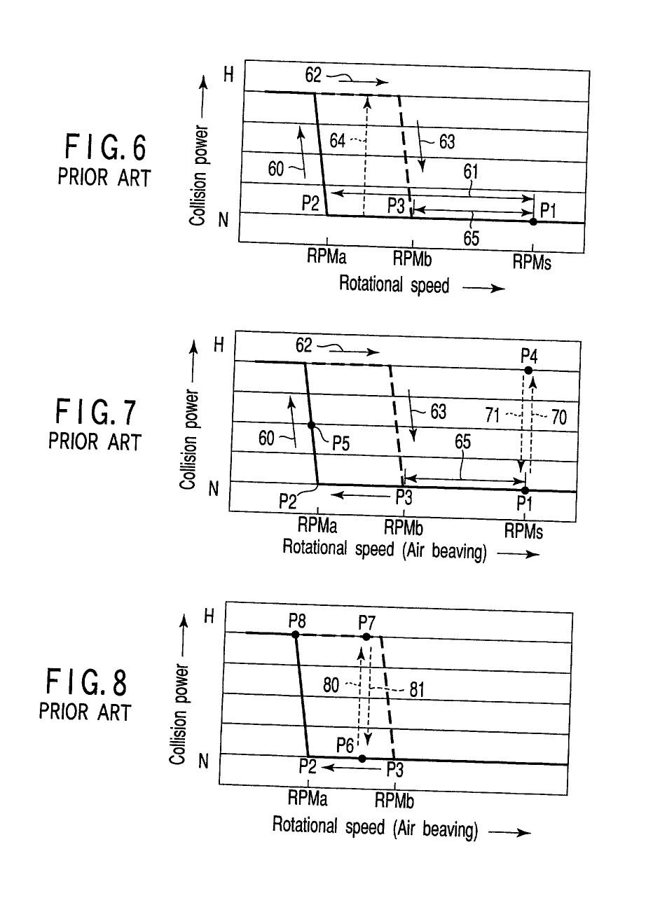

Reference will be made hereinafter to flowcharts of FIGS. 4 and 5 to describe the operation of the embodiment of the present invention.

When the power is applied to the disk drive, the CPU 8 drives the actuator 4 to perform a load operation of moving the head 2 from its rest position (20) to the disk 1 (refer to FIG. 2). Further, the CPU controls the motor driver 6 through the servo controller 7 to perform servo control for placing the head 2 in a selected position (read/write position) on the disk 1.

Suppose here a situation where disturbance, such as shock or abrupt drop in air pressure, acts on the disk drive, so that the head 2 loses its normal flying height and comes into collision (contact) with the disk 1. Upon detecting collision of the head 2, the collision monitor 11 notifies the CPU 8 of the occurrence of collision (step S1). The CPU 8 then measures the number of collisions and the time of continuous contact and stores them in the memory 13 as collision related information.

The CPU 8 references the collision related information stored in the memory 13 to make a decision of whether or not the head 2 has been placed in the state of continuous contact (step S2). Knowing from the collision related information that the frequency at which collisions occur within a fixed period of time is high and the continuous contact time exceeds a given reference time, the CPU 8 decides that the head 2 has been placed in the continuous contact state (YES in step S2). When the decision is otherwise, the CPU 8 carries out no special processing in the expectation that the collision or contact is momentary and the head 2 will be restored automatically to the proper flying height.

In the event of continuous contact, the CPU 8 stops the read/write operation for a moment and then switches to the following contact avoidance operation (step S3). First, based on environmental information concerning the air pressure, acceleration (corresponding to vibrations or shock), and temperature from the sensors 12, the CPU 8 decides whether or not the disturbance, such as a change in air pressure, acceleration, or a change in temperature, that causes the collision or contact of the head 2 with the disk 1 is still acting on the disk drive (step S4). In the case where the CPU 8 detects abnormal disturbance, it switches to a given emergency operation (as opposed to the contact avoidance operation) with the read/write operation stopped (YES in step 5, and step S9). The emergency operation is such an operation as unloads the head 2 to its rest position and stops the rotation of the disk 1.

When a particularly abnormal disturbance is not detected, on the other hand, the CPU 8 carries out the contact avoidance operation because there is not much likelihood that the head 2 will automatically restore its normal operating position (NO in step S5, and step S6). At the time of contact avoidance operation, as described previously in connection with FIG. 8, the head 2 has fallen from the normal floating state (point P6) into the contact state (point P7) due to disturbance (80).

The CPU 8 drives the actuator 4 via the servo controller 7 to perform an unload operation of moving the head 2 to its rest position (the member 20 in FIG. 2). Then, the CPU 8 immediately carries out a load operation of returning the head 2 from the rest position to the operating position over the disk 1. This allows the head 2 to escape from the state of contact with the disk 1 and be positioned to its normal flying height (point P6).

After the contact avoidance operation, the CPU 8 stores in the memory 13 the frequency at which collisions have been avoided (step S7). The CPU 8 then makes a decision of whether or not the frequency of collision avoidance has exceeded a specified value (step S8). In the event that the frequency of collision avoidance is outside a permissible range (the specified value is exceeded), the CPU 8 determines that the contact avoidance operation will not allow the head 2 to maintain its normal flying state with stability (the head is in the state where recovery from contact with the disk 1 is impossible) and then switches to the emergency operation (NO in step S8, and step S9). In this case, the state where recovery from contact with the disk 1 is impossible is the one at point P9 in FIG. 8.

Thus, the contact avoidance operation allows the head 2 to be restored to its normal flying state if the level of disturbance is within the permissible range and the head is in continuous contact with the disk. Specifically, the contact avoidance operation is effective for the continuous contact of the head with the disk which is liable to occur due to momentary disturbance in disk drives with low-flying heads. In this case, to restore the head to its original normal state, the read/write operation is simply stopped temporarily; thus, the degradation of the performance of the disk drive can be controlled. In addition, the reliability of the disk drive can be ensured because the continuous contact state is removed.

Reference will be made to FIGS. 3 and 5 to describe a modification of the contact avoidance operation. In this modification, to avoid contact of the head with the disk, the rotational speed of the disk is controlled.

It is supposed here that, as shown in FIG. 3, the head 2 has fallen from the normal floating state (point P6) into the contact state (point P7) due to disturbance (80). It is determined by the CPU 8 that the contact avoidance operation will restore the head from the contact state to its normal state.

The CPU 8 causes the servo controller 7 to stop servo control of the head 2 (step S11). That is, the head 2 is placed in the non-controlled state on the disk 1. Next, when no disturbance occurs, the CPU 8 causes the motor driver 6 to control the SPM 3 so that the rotational speed of the disk 1 is increased (NO in step S12, and step S13). In this case, the CPU 8 references the contact position and the frequency of avoidance in the collision related information stored in the memory 13 to set a target rotational speed of the disk 1. That is, depending on whether the contact position of the head 2 is on the inside or outside of the disk 1, the setting of the target rotational speed is changed. When it is found from the frequency of avoidance that the avoidance operation is carried out in succession, the CPU 8 performs a control operation of increasing the target rotational speed in steps from the initial setting. This allows a sufficient rotational speed of the disk to restore the head to its normal flying state to be attained.

The air pressure increases with increasing rotational speed of the disk 1. Therefore, as shown in FIG. 3, the head 2 follows the hysteresis curve (90) to make a transition from the contact state (point P7) to the higher-than-usual flying state (point P9). The flying state at point P9 corresponds to a rotational speed of the disk higher than the usual rotational speed (RPMs). Thus, the head 2 escapes from the contact state and comes to fly above the disk 1. At the time of contact, the slider on which the head 2 is mounted is vibrating; however, in the non-contact state, the vibration attenuates.

Next, the CPU 8 causes the motor driver 6 to control the SPM 3 again to return the rotational speed of the disk 1 to the usual rotational speed (step s14). The CPU 8 then resumes the operation of reading servo data from the disk 1 through the head 2 and starts servo control of the head 2 on the basis of the servo data (steps S15 and S16). As a result, the head 2 is restored from the higher flying state (point P9) to the normal flying state (point P6).

In the event of occurrence of disturbance, such as a shock, against the disk drive when the servo control of the head 2 has been stopped, on the other hand, the CPU 8 performs a forced unload operation of moving the head 2 to the rest position by causing the motor driver 6 to drive the head actuator 4 (YES in step S12, and step S17). The CPU 8 then carries out a load operation of moving the head 2 from its rest position to the disk 1 by driving the actuator 4 again (step S18). This allows the minimum reliability to be ensured against momentary disturbance.

A modification of the emergency operation will be described next. As described previously, in the event of abnormal disturbance beyond the permissible range, the CPU 8 switches to the emergency operation (as opposed to the contact avoidance operation) with the read/write operation stopped (refer to step S9 in FIG. 4). The emergency operation in this case is to unload the head 2 to its rest position (the ramp 20 in FIG. 2) and stop the rotation of the stop 1.

In the modification of the emergency operation, the rotational speed of the disk 1 is changed prior to the unload operation. That is, the CPU 8 first causes the servo controller 7 to stop the servo control of the head 2. Next, the CPU 8 causes the motor driver 6 to drive the SPM 3 to increase the rotational speed of the disk 1. In this case, the CPU 8 makes reference to the position of contact in the collision related information stored in the memory 13 to set a target rotational speed of the SPM 3.

Since the air pressure increases with increasing rotational speed of the disk 1, the head 2 goes from the contact state (point P7) to the higher-than-usual flying state (point P9) as described previously in connection with FIG. 3. The CPU 8 unloads the head 2 to its rest position (the ramp member 20) with the head 2 kept in the higher flying state.

Such an emergency operation can move the head 2 to its rest position with separation from the disk 1, thus allowing the head 2 or the disk 1 to be prevented from being damaged.

According to the present invention, as described so far, a disk storage apparatus can be provided which has a function of, in the event that a flying head comes into contact with the surface of a rotating disk and if recovery from the contact state is possible, restoring the head to its normal flying state. Thus, by performing the contact avoidance operation temporarily when disturbance is detected, recovery from the contact state can be made. Damage to the head and disk due to contact between them can be held down to the minimum, allowing the reliability of the disk drive to be ensured. In addition, by simply stopping the read/write operation temporarily, the head can be restored to its normal flying height to continue the operation of the disk drive, allowing the degradation of the performance of the disk drive to be kept at a minimum. In particular, the present invention is very useful in disk drives with low-flying heads adapted for high-density recording because the reliability is ensured and the degradation of the performance is kept to a minimum.

What is claimed is:

1. A disk drive comprising:
a head adapted to fly above the surface of a rotating disk for reading or writing data on the disk;
a collision monitor which detects continuous (or continual?) contact of the head with the surface of the disk;
a sensor which detects disturbance; and
a controller for, in the event that the continuous (or continual) contact of the head with the surface of the disk is detected by the collision monitor and disturbance is detected by the sensor, performing a head contact avoidance operation.

2. A disk drive according to claim 1, wherein the controller performs the contact avoidance operation by increasing the rotational speed of the disk above its normal rotational speed to thereby increase the flying height of the head above the rotating disk.

3. A disk drive according to claim 2, wherein the controller restores the disk to its normal rotational speed to thereby restore the head to its original state.

4. A disk drive according to claim 1, wherein the controller performs the contact avoidance operation by carrying out an unload operation of moving the head to a given position outside the disk.

5. A disk drive according to claim 4, wherein the controller loads he head from the given position outside the disk to a given position above the disk to thereby restore the head to its original state.

6. A disk drive according to claim 1, wherein the controller includes storage means for storing the frequency at which the contact avoidance operation is performed and, when the frequency of the contact avoidance operation is beyond a permissible range, carries out a given emergency operation.

7. A disk drive according to claim 1, wherein the collision monitor determines that the head is continuous contact with the surface of the disk on the basis of a change in a read signal corresponding to servo data prerecorded on the disk when it is read by the head.

8. A disk drive according to claim 1, wherein the sensor is one for sensing air pressure.

9. A disk drive according to claim 8, wherein the controller carries out a given emergency operation in the event that the sensor detects, as the disturbance, air pressure outside a permissible range which is abnormally low in comparison with the standard air pressure.

10. A disk drive according to claim 1, wherein the sensor is an acceleration sensor for detecting an externally applied shock.

11. A disk drive according to claim 10, wherein the controller performs an emergency operation of stopping the move control of the head at the start of the contact avoidance operation and, in the event that a shock is detected by the acceleration sensor, performing a forced unload operation of forcibly moving the head to a given position outside the disk.

12. A disk drive according to claim 1, wherein the sensor is one for detecting ambient temperature.

13. A disk drive according to claim 12, wherein the controller carries out a given emergency operation in the event that the sensor detects, as the disturbance, temperature outside a permissible range which is abnormal in comparison with the standard temperature.

14. For use with a disk drive having a head adapted to fly above the surface of a rotating disk for reading or writing data on the disk, a method of avoiding contact or collision of the head with the surface of the disk, the method comprising:
detecting continuous contact of the head with the surface of the disk;
detecting disturbance to the disk drive; and
performing a head contact avoidance operation in the event that the continuous contact of the head with the surface of the disk is detected and disturbance is detected.

15. The method according to claim 14, further comprising the step of restoring the head to its original state after the completion of the head contact avoidance operation.

16. The method according to claim 14, further comprising the performing a given emergency operation when the degree of the disturbance is outside a permissible range.

17. The method according to claim 14, further comprising the stopping restoring the head to its original state when the degree of the disturbance is outside a permissible range.

18. The method according to claim 14, further comprising the performing a forced unload operation of stopping the move control of the head at the start of the contact avoidance operation and, in the event that disturbance is detected, forcibly moving the head to a given position outside the disk.

19. The method according to claim 14, wherein the contact avoidance operation comprises increasing the rotational speed of the disk above its normal rotational speed to thereby increase the flying height of the head above the rotating disk.

20. The disk drive according to claim 14, further comprising, as the head contact avoidance operation, increasing the rotational speed of the disk above its normal rotational speed to thereby increase the flying height of the head above the rotating disk; and, after the completion of the head contact avoidance operation, restoring the disk to its normal rotational speed to thereby restore the head to its original state.
